(19) United States
(12) Patent Application Publication
(10) Pub. No.: US 2013/0171414 A1
(43) Pub. Date: Jul. 4, 2013

(54) ROOFING PRODUCT WITH ENHANCED PROPERTIES FOR PROCESSING RAIN WATER

(71) Applicants: MING LIANG SHIAO, COLLEGEVILLE, PA (US); GREGORY F. JACOBS, ORELAND, PA (US)

(72) Inventors: MING LIANG SHIAO, COLLEGEVILLE, PA (US); GREGORY F. JACOBS, ORELAND, PA (US)

(21) Appl. No.: 13/723,473

(22) Filed: Dec. 21, 2012

Related U.S. Application Data
(60) Provisional application No. 61/581,183, filed on Dec. 29, 2011.

(51) Int. Cl. E04D 1/20; B32B 5/16; E04D 13/04

(52) U.S. Cl. CPC E04D 1/20; E04D 13/0404; B32B 5/16
USPC 428/144; 428/143; 428/149; 428/195.1; 428/403

(57) ABSTRACT

A roofing product that filters and facilitates rain water collection has a substrate with roofing granules that may be configured to perform a water filtering function. The roofing granules may have a porous composite structure comprising a UV-opaque core and a water filtering layer around the core. The roofing product may include a substrate with a first layer on the substrate. The first layer may have a printed pattern or texture to simulate roofing materials, and a protective layer may be formed on the first layer.

### BACKGROUND OF THE INVENTION

1. Field of the Disclosure

The present invention relates in general to roofing materials and, in particular, to a system, method and apparatus for roofing products with enhanced properties for rain water harvesting.

2. Related Art

Water from natural sources is becoming increasingly scarce in supply due to over-population, increased agricultural activities, and climate changes. As a result, many areas and localities have implemented water management policies or incentives to encourage collecting rain water and storing it for later uses in non-drinking water applications. For example, island nations such as Bermuda require ceramic or concrete roof tile systems and water collection cisterns to capture water from passing storms. However, most of the rain water falling on conventional roofs is not collected for further utilization, but is directly released to the ground via rain gutter systems, which can add to a surge of storm water or erosion of ground covering.

It is therefore beneficial to have a system that can collect rain water from a roof to conserve water resources. Currently, there are rain water catchment systems in which rain water is collected and later used for irrigation purposes. Such systems usually comprise an extra attachment to the rain gutter, and can be bulky or aesthetically unpleasing. Therefore, it would be further beneficial to have a roof-integrated water collecting system that can collect rain water while maintaining the aesthetics of the building envelope. In addition, in some areas where the water supply is limited, it would be beneficial to expand the use of collected rain water for non-irrigation purposes.

About 80% of the roofs in the U.S. are covered by asphalt or bitumen-based shingles. These mineral-surfaced asphalt shingles, such as those described in ASTM D225 or D3462, are generally used in steep-sloped roofs to provide a water-shedding function while adding an aesthetically-pleasing appearance to the roofs. Asphalt shingles are generally constructed from asphalt-saturated roofing felts/mats and are surfaced by pigmented color granules, such as those described in U.S. Pat. No. 4,717,614. Such a surface may not be ideal for collecting rain water for non-irrigation use without extensive filtering and treatments. Also, due to the rough, granulated surfaces of roofing shingles, such surfaces do not readily facilitate water collection as they tend to be relatively rough and uneven. This causes water to be retained or evaporated instead of being collected.

U.S. Pat. No. 7,025,076 discloses a system and method for restoring the natural water cycle by reducing storm water runoff and addressing issues affecting groundwater supply. WO/02086253A1 discloses a device for collecting and storing water from the environment. U.S. Pat. No. 7,661,904 discloses a water conservation and distribution system. U.S. Pat. No. 6,539,683 discloses a directional drainage roofing shingle. U.S. Pat. No. 7,743,573 discloses a roofing shingle construction for use on buildings. It has a drainage layer to direct water downslope beneath a drainage layer, and a separation layer between the drainage layer and a storage layer to support the storage layer.

Each of those references approaches the problem described herein in a macrostructural way, and does not incorporate water catchment or treatment facilities into an asphalt roofing shingle or roofing membrane. It would be beneficial to have a roofing shingle that has an upper surface engineered such that it can provide a clean, easy path for water to be quickly collected. It would be further beneficial for such a surface to additionally provide filtering and purification functions so that the water collected would be suitable for certain internal uses.

### SUMMARY

Embodiments of a roofing product may include a substrate and roofing granules on the substrate. The roofing granules may be configured to perform a water filtering function, the roofing granules having a porous composite structure comprising a UV-opaque core and a water filtering layer on the UV-opaque core. In some embodiments, the roofing granules may form an outer surface of the roofing product. The outer surface may have a texture with a surface roughness Rₐ in a range of about 0.05 mm to about 0.5 mm.

Alternatively, a layer may be formed on or applied to the substrate and may have a printed pattern or texture to simulate roofing materials. A protective layer may be formed on the first layer. In other embodiments, a roofing granule may include a porous composite structure having a UV-opaque core. A water filtering layer may be provided on the UV-opaque core, and the roofing granule may be adapted to perform a water filtering function on a roofing product.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and may be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIGS. 1A-1C are schematic sectional side views of embodiments of roofing shingles; and

FIG. 2 is a sectional view of an embodiment of a roofing granule for roofing shingles.

The use of the same reference symbols in different drawings indicates similar or identical items.

### DETAILED DESCRIPTION

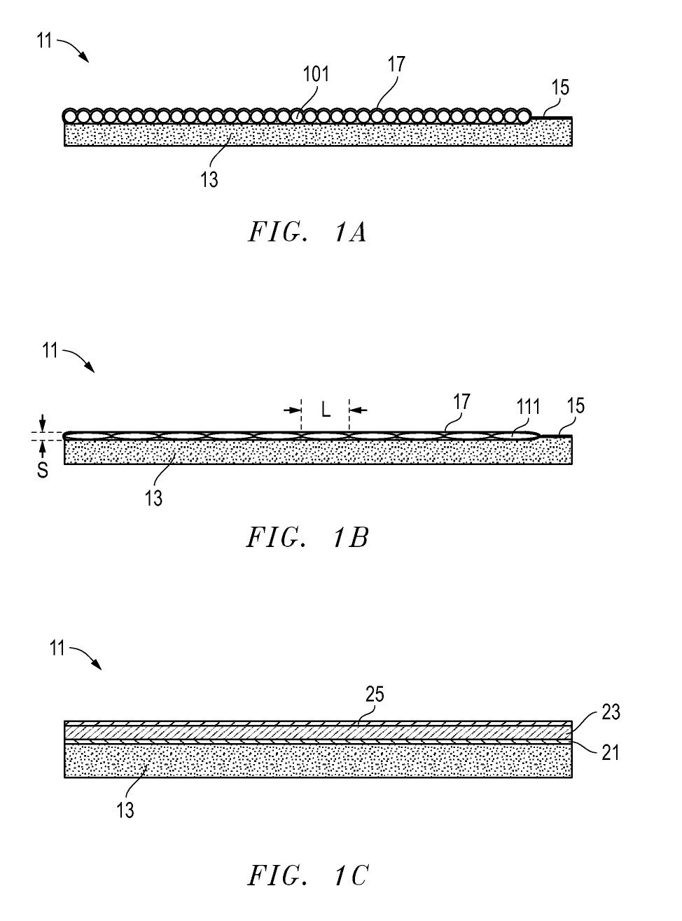

Embodiments of roofing products that may filter and/or help collect rain water are disclosed. For example, FIG. 1A depicts an embodiment of a roofing product 11 comprising a substrate 13 having roofing granules 101 on the substrate 13 configured to perform a water filtering function. The roofing granules 101 may form an outer surface of the roofing product 11. The outer surface may have a texture with a surface roughness Rₐ in a range of about 0.05 mm to about 0.5 mm. Rₐ may be defined as the arithmetical mean deviation of the profile. Testing standards for Rₐ include ISO 4287 and DIN 4768. In addition the surface roughness may be characterized by Rₘₐₓ in a range of about 0.1 mm to about 1 mm. As disclosed in ASTM D7127 and DIN 4768, Rₘₐₓ may be defined as the maximum profile valley depth.

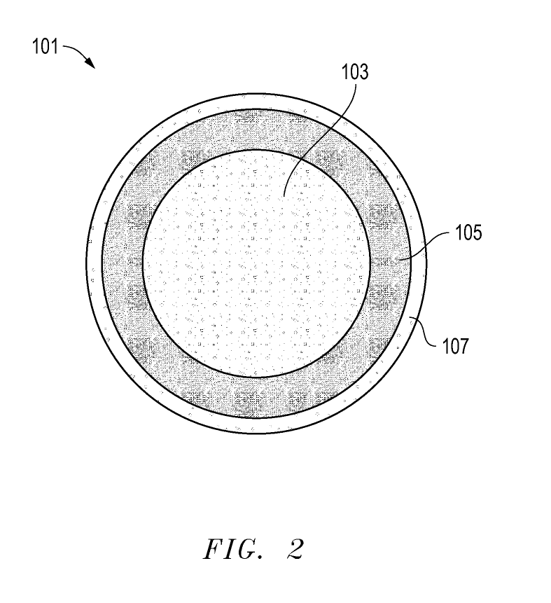

An embodiment of the roofing granules 101 is shown in detail in FIG. 2. Roofing granules 101 may have a porous composite structure comprising a UV-opaque core 103 and a water filtering layer 105 on the UV-opaque core 103. In some embodiments, the UV-opaque core may be defined as having a UV opacity greater than about 90%, as tested according to ARMA Granule Test Procedures Manual method #9. The roofing granules 101 may further comprise an outer color coating 107 that may be water-permeable and UV-transparent for photocatalytic cleaning in the filtering layer.

The water filtering layer 105 may comprise a matrix phase, an interconnecting pore phase or interconnecting channels, and a filtering phase. The matrix phase may be UV-transparent. The filtering phase may comprise at least one of photocatalytic particles, activated carbon, sediment trapping zones, anti-microbial compounds, and chemical/organic sorbent. The activated carbon also may provide a printed pattern or texture to simulate roofing materials.

In other embodiments, the water filtering layer 105 may comprise at least one of SiOₓ, silicates, geopolymers, fluoropolymers, silicones, and polysiloxanes. In addition, the water filtering layer 105 may have a porosity in a range of about 5% to about 50%, in some embodiments.

In still other embodiments, the roofing granules 101 may have a particle size in a range of about 0.2 mm to about 3.5 mm, or about 0.25 mm to about 3 mm, or about U.S. mesh #6 to #60.

In addition, the roofing granules 101 may be distributed on the substrate 13 to reduce surface friction. For example, the roofing product 11 may be provided with a surface friction in a range of about 0.03 to about 0.3. The standard for testing surface friction is ASTM C1028.

Other parameters may be used to characterize the performance of the embodiments disclosed herein. For example, in fluid dynamics, drag or fluid resistance refers to forces which act on a solid object in the direction of the relative fluid flow velocity. Unlike other resistive forces such as dry friction, which is nearly independent of velocity, drag forces depend on velocity. Drag forces always decrease fluid velocity relative to the solid object in the fluid's path.

Embodiments of the roofing product 11 may further comprise a primer or seal coat 15 (FIG. 1A). Seal coat 15 may comprise a polymer and may be located between the substrate 13 and the roofing granules 101 to prevent water contamination from the substrate 13. In other embodiments, the roofing product 11 also may further comprise a top coat or top layer 17 on top of the roofing granules 101. The top coat or top layer 17 may have a hydrophobic surface configured to improve the water shedding or run rate from the roofing product 11.

As shown in FIG. 1B, embodiments of the roofing granules 111 may have a flake-like shape. This shape may comprise a long dimension L oriented toward a surface of the substrate 13, and a short dimension S substantially orthogonal to the long dimension L. An aspect ratio of L/S may be in a range of about 2 to about 20. In some versions, such roofing granules 111 may comprise slate.

In still other embodiments, the roofing product 11 is a bitumen-based roofing shingle. The surface may be sealed with the seal coat 15 prior to deposition of the roofing granules 101, 111. The substrate 13 may comprise thermoplastic polyolefin (TPO), polyvinylchloride (PVC), polyurethane (PU), acrylic, fluoropolymer or may be bitumen-based.

Referring now to FIG. 1C, some embodiments of the roofing product 11 may comprise the substrate 13 with a first layer 21 on the substrate 13. The first layer 21 may have a printed pattern or texture to simulate roofing materials. The first layer may include a film or a coating that does not contain granules.

In addition, a protective layer 23 may be formed on the first layer 21, in some embodiments. The roofing product 11 may still further comprise a top coat or top layer 25 on the protective layer 23. The top coat or top layer 25 may have a hydrophobic surface that may be configured to improve the water run rate from the roofing product 11.

The elements and features of the various embodiments may be combined in any way. For example, at least one of the layers of FIG. 1C may be configured to perform the water filtering function via a porous composite structure comprising a UV-opaque core and a water filtering layer on the UV-opaque core.

Roofing shingles such as those disclosed herein may be configured with an upper surface that is designed to allow for easy water run-off in a sloped roof to facilitate water collection. Such a surface also can have additional layers that provide extra functions such as filtering, purification, sanitization, etc. In addition, embodiments of the roofing shingle can have an enclosed integrated system that may comprise part of the building envelope for aesthetic reasons while minimizing external contaminations for water collection.

In one aspect, embodiments of the shingle may have a surface that has smoother texture as compared to traditional asphalt shingles. The surface may be constructed by granules that are smaller in particle size, in optimal size distributions and/or shapes for minimizing surface friction, or flaky particle shapes that result in high surface coverage and low surface roughness. In still other versions, embodiments of granules with smooth surfaces or hydrophobic surfaces may be used. In another example, the surface can include a film or coating that does not contain surfacing media. Such a surface can be printed or textured to provide desirable appearance, depending on the application. In some examples of bitumen-based roofing shingles, the surface may be sealed with a polymer layer prior to deposition of the surfacing granules, such that the undesirable oils or leachable contaminants do not affect the quality of the water that is collected.

In another aspect, embodiments of the surface of the shingle can have a filtering function. Some filtering functions may be provided by incorporating a surfacing granule having a porous composite structure that comprises a UV opaque core, and a filtering layer having a matrix phase, an interconnecting pore phase or inter-connecting channels, and a filtering phase. Embodiments of the particle also can have an optional outer color coating that is water-permeable and UV transparent for photocatalytic cleaning in the filtering layer. The composite particles may be provided with strength and integrity for outdoor roofing applications, as well as be able to pass through the manufacturing process of a roofing shingle. The core of the composite particles also may be provided with adequate UV opacity to protect the asphalt in bitumen based substrates.

For the filtering layer, embodiments of the matrix phase may provide the strength and integrity for supporting filtering phase. Adequate porosity may be provided such that the water can be filtered therethrough in a desirable time during which the water can be cleaned. Suitable materials may include, but are not limited to, SiOₓ, silicates, geopolymers, fluoropolymers, silicones, or polysiloxanes. Examples of the filtering phase comprise photocatalytic particles, activated carbon, sediment trapping, anti-microbial, chemical/organic sorbent, or their combination. The material for matrix phase should be UV transparent and have adequate mechanical strength that can provide the backbone and compressive strength of the said particle.

### EXAMPLE

Four test roof decks, each measuring 30 inches by 40 inches, were constructed to test the effects of improving surface morphology of roofing products on the quality and amount of rainwater catchments. Each of the four configurations is described in Table 1.

TABLE 1

| Test | | Observation of |
|---|---|---|
| Roof | Description | Rain Water Collected |
| 1 | 20-year, 3-tab shingle in | light tan discoloration with black |
| | weathered wood color | suspensions and light oil on |
| | | surface. Settlement of granule and |
| | | dust on bottom |
| 2 | 25-year, 3-tab shingle in white | clear color with some particle |
| | color, and algae resistant | settlements |
| 3 | 30-year, laminate shingle in | light tan discoloration with some |
| | black color, and algae | contaminant suspensions and |
| | resistant | some granules settlements |
| 4 | Same as Test Roof 1, but with | clear color with no settlement or |
| | surface sealed by polymeric | discoloration |
| | coating | |

The test roofs were constructed over a ¾-inch thick plywood deck, a 30 lb roofing felt as underlayment, and the asphalt shingles as the roof covering. The slopes of the test roofs were 6/12, and the test roofs were located about four feet above the ground with a south-facing orientation in an open space. A standard aluminum gutter was attached to the eaves of each roof to collect the rain runoffs. The runoffs were collected into gallon-sized plastic containers via PVC tubing. The containers had volume graduation for recording the total amount collected. Test Roof 4 was identical to Test Roof 1, except that the outer surfaces of the asphalt shingles on Test Roof 4 were was sealed with an exterior grade acrylic clear coating (Acrynol Optive, available from BASF Corporation, Florham Park, N.J.) at a thickness of about 10 mil (dry).

The test roofs were tested during the summer season in a suburban setting of a metropolitan city on the east coast of the U.S. The total amounts of rain water runoffs collected during each rain period were found to be more than the capacities of the plastic containers. As a result, the total amounts of runoffs were not recorded. After each rain period, the quality of the water collected was first visually examined to determine water colorations and whether contaminants or settlements were present. The results of the visual examinations are described in Table 1. Rain water collected from the test roofs also was sampled immediately after each rain period in 500-ml, pre-cleaned glass bottles with sealed caps suited for water analysis. The water samples were shipped overnight to a NELAP certified test lab for analysis. The results of the water analyses are summarized in Table 2.

TABLE 2

| Com- | | Car- | Deck | Deck | Deck | Deck |
|---|---|---|---|---|---|---|
| pound | EPA limit | cinogen | #1 | #2 | #3 | #4 |
| calcium | 0.56 mg/L | | 1.6 | 2.4 | 3 | <0.56 |
| sodium | 0.56 mg/L | | 2.2 | 1.4 | 2.5 | 1.5 |
| aluminum | 0.22 mg/L | | <0.22 | <0.22 | <0.22 | <0.22 |
| arsenic | 0.0050 mg/L | Group | <0.11 | <0.11 | <0.11 | <0.11 |
| | | A | | | | |
| copper | 0.06 mg/L | | 0.23 | <0.060 | <0.060 | <0.060 |

As shown in Table 1 and Table 2, the quality of the water collected from Test Roof No. 4 was found to have few contaminants and also improved water quality (especially lower metal ions), with respect to the other three test roofs.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A roofing product, comprising:
a substrate; and
roofing granules on the substrate configured to perform a water filtering function, the roofing granules having a porous composite structure comprising a UV-opaque core and a water filtering layer on the UV-opaque core.

2. A roofing product according to claim 1, wherein the water filtering layer comprises a matrix phase, an interconnecting pore phase or interconnecting channels, and a filtering phase.

3. (canceled)

4. (canceled)

5. A roofing product according to claim 1, wherein the water filtering layer comprises at least one of SiOₓ, silicates, geopolymers, fluoropolymers, silicones, and polysiloxanes.

6. (canceled)

7. A roofing product according to claim 1, wherein the roofing granules further comprise an outer color coating that is water-permeable and UV-transparent for photocatalytic cleaning in the filtering layer.

8. (canceled)

9. (canceled)

10. A roofing product according to claim 1, further comprising a primer or seal coat between the substrate and the roofing granules to prevent water contamination from the substrate.

11. A roofing product according to claim 1, further comprising a top coat or top layer on top of the roofing granules, the top coat or top layer having a hydrophobic surface configured to improve water run rate from the roofing product.

12. (canceled)

13. (canceled)

14. A roofing product according to claim 1, wherein the roofing product is a bitumen-based roofing shingle, and the surface is sealed with a polymer layer prior to deposition of the roofing granules.

15. (canceled)

16. A roofing product, comprising:
a substrate having a surface; and
roofing granules on the substrate to form an outer surface of the roofing product, and the outer surface has a texture with a surface roughness Rₐ in a range of about 0.05 mm to about 0.5 mm.

17. A roofing product according to claim 16, wherein the roofing granules further comprise an outer color coating that is water-permeable and UV-transparent for photocatalytic cleaning in the filtering layer.

18. (canceled)

19. A roofing product according to claim 16, further comprising a primer or seal coat between the substrate and the roofing granules to prevent water contamination from the substrate.

20. A roofing product according to claim 16, further comprising a top coat or top layer on top of the roofing granules, the top coat or top layer having a hydrophobic surface configured to improve water run rate from the roofing product.

21. (canceled)

22. (canceled)

23. (canceled)

24. A roofing product according to claim 16, wherein the roofing product is a bitumen-based roofing shingle, and the surface is sealed with a polymer layer prior to deposition of the roofing granules.

25. (canceled)

26. A roofing product according to claim 16, wherein the roofing granules on the substrate are configured to perform a water filtering function, and the roofing granules have a porous composite structure comprising a UV-opaque core and a water filtering layer on the UV-opaque core.

27. (canceled)

28. (canceled)

29. (canceled)

30. (canceled)

31. (canceled)

32. A roofing product, comprising:
a substrate;
a first layer on the substrate, the first layer having a printed pattern or texture to simulate roofing materials; and
a protective layer on the first layer.

33. A roofing product according to claim 32, further comprising a top coat or top layer on the protective layer, the top coat or top layer having a hydrophobic surface configured to improve water run rate from the roofing product.

34. A roofing product according to claim 32, wherein the first layer is a film or coating that does not contain granules.

35. (canceled)

36. A roofing product according to claim 32, wherein at least one of the layers is configured to perform a water filtering function via a porous composite structure comprising a UV-opaque core and a water filtering layer on the UV-opaque core.

37. (canceled)

38. (canceled)

39. (canceled)

40. (canceled)

41. (canceled)

42. (canceled)

43. (canceled)

44. (canceled)

45. A roofing product according to claim 32, wherein the printed pattern or texture comprises activated carbon.

46. (canceled)

47. A roofing granule, comprising:
a porous composite structure having a UV-opaque core, a water filtering layer on the UV-opaque core, and the roofing granule is adapted to perform a water filtering function on a roofing product.

48. A roofing granule according to claim 47, wherein the water filtering layer comprises a matrix phase, an interconnecting pore phase or interconnecting channels, and a filtering phase.

49. (canceled)

50. A roofing granule according to claim 47, wherein the filtering phase comprises at least one of photocatalytic particles, activated carbon, sediment trapping zones, anti-microbial compounds, and chemical/organic sorbent.

51. (canceled)

52. (canceled)

53. A roofing granule according to claim 47, further comprising an outer color coating that is water-permeable and UV-transparent for photocatalytic cleaning in the filtering layer.

54. (canceled)

55. (canceled)
